(19) United States
(12) Patent Application Publication
(10) Pub. No.: US 2025/0078663 A1
(43) Pub. Date: Mar. 6, 2025

(54) SAFETY SYSTEM FOR THE LOCALIZATION OF AT LEAST TWO VEHICLES AND METHOD OF LOCALIZING AT LEAST TWO VEHICLES

(71) Applicant: SICK AG, Waldkirch (DE)

(72) Inventors: Holger WAIBEL, Waldkirch (DE); Florian GEISSER, Waldkirch (DE)

(21) Appl. No.: 18/599,536

(22) Filed: Mar. 8, 2024

(30) Foreign Application Priority Data
Mar. 17, 2023 (DE) 102023106694.3

(51) Int. Cl. G08G 1/00; B60W 30/16; G05D 1/69; G05D 109/10; G05D 111/30; G05D 111/50; H04W 4/44

(52) U.S. Cl. CPC G08G 1/22; B60W 30/16; G05D 1/69; H04W 4/44; B60W 2554/4041; B60W 2554/802; B60W 2556/45; G05D 2109/10; G05D 2111/32; G05D 2111/52

(57) ABSTRACT

A safety system and a method for the localization of at least two vehicles have at least one control and evaluation unit and at least one radio location system. The radio location system has at least three arranged radio stations. At least one device has at least one radio transponder arranged at the vehicles. The radio location system is configured to determine position data of the radio transponder and thus to determine position data of the vehicles. The position data can be transmitted from the radio station of the radio location system to the control and evaluation unit and/or the position data can be transmitted from the radio transponder to the control and evaluation unit. The control and evaluation unit is configured to cyclically detect the position data of the radio transponder. The radio transponder has an identification and the control and evaluation unit is configured to distinguish the vehicles.

The present invention relates to a safety system for the localization of at least two vehicles and respectively to a method of localizing at least two vehicles.

EP 3 401 702 B1 discloses a safety system for an arrangement of driverless transport vehicles, wherein each driverless transport vehicle has an identification identifying it at its rear side, and wherein each driverless transport vehicle has sensor means at its front side that are configured to determine the identification and the distance of a preceding driverless transport vehicle, and wherein sensor signals generated by the sensor means are evaluated in an evaluation unit and control signals are generated in dependence thereon by means of which the speed of the driverless transport vehicle is controlled, wherein the identification and the distance of the preceding transport vehicle are detected by the same sensor means, wherein the sensor means are formed by an optical sensor, and wherein the optical sensor is configured for a protected field monitoring.

An object of the invention comprises optimizing a convoy travel of vehicles and of avoiding a collision between vehicles.

The object is satisfied in accordance with claim 1 by a safety system for the localization of at least two vehicles, having at least one control and evaluation unit, having at least one radio location system, wherein the radio location system has at least three arranged radio stations, wherein at least one device having at least one radio transponder is arranged at the vehicles, wherein the radio location system is configured to determine position data of the radio transponder and thus to determine position data of the vehicles, wherein the position data can be transmitted from the radio station of the radio location system to the control and evaluation unit and/or the position data can be transmitted from the radio transponder to the control and evaluation unit, wherein the control and evaluation unit is configured to cyclically detect the position data of the radio transponder, wherein the radio transponder has an identification, wherein the control and evaluation unit is configured to distinguish the vehicles, wherein the control and evaluation unit is configured to control the vehicles, wherein the control and evaluation unit is configured to combine the vehicles into groups driving in the same direction based on the position data of the vehicles, and wherein the control and evaluation unit is configured to reduce the distances between the vehicles of a group.

The object is further satisfied in accordance with claim 14 by a safety system for the localization of at least two vehicles, having at least one control and evaluation unit per vehicle, having at least one radio location system, wherein the radio location system has at least one arranged radio transceiver at the vehicle, wherein the radio location system is configured to determine distance data of the radio transponders and thus to determine distance data of the vehicles, wherein the distance data can be transmitted from the radio transceiver of the radio location system to the control and evaluation unit, wherein the control and evaluation unit is configured to cyclically detect the distance data of the radio transceiver, wherein the radio transceiver has an identification, wherein at least one of the control and evaluation units is configured to distinguish the vehicles, wherein the control and evaluation unit is configured to control at least the vehicle, wherein the control and evaluation unit is configured to combine the vehicles into groups driving in the same direction based on the distance data of the vehicles, and wherein the control and evaluation unit is configured to reduce the distances between the vehicles of a group.

The object is further satisfied in accordance with claim 27 by a method of localizing at least two vehicles, having at least one control and evaluation unit, having at least one radio location system, wherein the radio location system has at least three arranged radio stations, wherein at least one device having at least one radio transponder is arranged at the vehicles, wherein position data of the radio transponder and thus position data of the vehicles can be determined by means of the radio location system, wherein the position data can be transmitted from the radio station of the radio location system to the control and evaluation unit and/or the position data can be transmitted from the radio transponder to the control and evaluation unit, wherein the control and evaluation unit is configured to cyclically detect the position data of the radio transponder, wherein the radio transponder has an identification, wherein the control and evaluation unit is configured to distinguish the vehicles, wherein the control and evaluation unit is configured to control the vehicles, wherein the control and evaluation unit is configured to combine the vehicles into groups driving in the same direction based on the position data of the vehicles, and wherein the control and evaluation unit is configured to reduce the distances between the vehicles of a group.

The object is further satisfied in accordance with claim 28 by a method of localizing at least two vehicles, having at least one control and evaluation unit per vehicle, having at least one radio location system, wherein the radio location system has at least one arranged radio transceiver at the vehicle, wherein distance data of the radio transceiver and thus distance data of the vehicles can be determined by means of the radio location system, wherein the distance data can be transmitted from the radio transceiver of the radio location system to the control and evaluation unit, wherein the control and evaluation unit is configured to cyclically detect the distance data of the radio transceiver, wherein the radio transceiver has an identification, wherein the control and evaluation unit is configured to distinguish the vehicles, wherein at least one of the control and evaluation units is configured to control at least the vehicle, wherein the control and evaluation unit is configured to combine the vehicles into groups driving in the same direction based on the distance data of the vehicles, and wherein the control and evaluation unit is configured to reduce the distances between the vehicles of a group.

The distances are, for example, reduced in comparison with the status before the vehicles have formed a group. The distances are, for example, reduced in comparison with vehicles that have not been combined into a group.

The localization of the radio transponders takes place by time of flight measurements of radio signals that are cyclically exchanged between the radio transponders and a plurality of fixed position radio stations.

In accordance with a first embodiment of the invention, the signals of a radio transponder are received by a plurality of fixed position radio stations or anchor stations and the basis for the localization is created via a time of flight measurement, e.g. the time of arrival (TOA) or e.g. the time difference of arrival (TDOA). The calculation or estimation of the position of a radio transponder then takes place on the control and evaluation unit, for example an RTLS (real time location system) server that is connected to all the radio stations or anchor stations via a wireless or wired data link. This mode of localization is called an RTLS (real time location system) mode.

In accordance with a second embodiment of the invention (TWR—two way ranging), the signals of the radio transceiver on a vehicle are received by at least one radio transceiver on a different vehicle and the basis for a distance measurement is created via a time of flight measurement, e.g. the time of arrival (TOA). The calculation or estimation of the distance between the radio transceivers then takes place on the respective control and evaluation unit. The vehicles here exchange their distances or spacings and the control signals for the group or convoy between one another.

At least one of the control and evaluation units is configured to combine the vehicles into groups driving in the same direction based on the position data or distance data of the vehicles, wherein the control and evaluation unit is configured to reduce the distances between the vehicles of a group.

At least two vehicles or a plurality of vehicles are present, for example, and are underway in a factory workshop, for example.

The vehicle can, for example, be a guideless vehicle, a driverless vehicle or an autonomous vehicle, an autonomous guided vehicle (AGV), an autonomous mobile robot (AMR), an industrial mobile robot (IMR), or a robot having movable robot arms. The vehicle thus has a drive and can be moved in different directions.

Persons can furthermore also be present and can, for example, be underway in a factory workshop. The person can, for example, be an operator or a service engineer.

A number of vehicle have at least one radio transponder or one radio transceiver.

Data or information can be exchanged between the vehicles over the radio location system.

However, all the vehicles do not have to have a radio transponder or a radio transceiver. Conventional vehicles in accordance with the prior art can also be present. These conventional vehicles, for example, have local safety sensors for collision avoidance.

However, all the vehicles of a group in accordance with the invention have at least one radio transponder or one radio transceiver.

The possibility of the vehicles being able to merge into a group or convoy is recognized with reference to the position of the vehicles among one another. The group, the group travel or convoy travel is initiated, for example, when certain requirements have been satisfied. For example, a planned common route.

As soon as the vehicles have been combined into a group, the distances between the vehicles can be set. As soon as the vehicles drive in the same direction, the distances between the vehicles of a group are reduced or minimized.

A permitted minimum distance is provided between the vehicles, for example. The minimum distance can be set in dependence on the current speed of the vehicle.

Control signals are exchanged between the vehicles, for example. When the vehicles have been combined into a group or convoy, the vehicles control themselves between one another or the superior control and evaluation unit controls the vehicles such that the distances between the vehicles are minimal.

Braking signals are exchanged between the vehicles, for example. When a vehicle initiates a braking procedure, a signal is sent so that all the following vehicles also initiate a braking procedure.

Acceleration signals are exchanged between the vehicles, for example. When the first vehicle accelerates, it sends a signal to the other vehicles so that these vehicles also accelerate.

If all the vehicles are not centrally controlled, the signals are forwarded, for example, from one vehicle to the next vehicle in the group or chain.

Control signals are exchanged between the vehicles, for example. All the vehicles in the group or convoy can thus also be braked, for example, that is also the preceding vehicles. It can thus be prevented that the group or convoy falls apart when a middle, a rear, or, for example, the last vehicle brakes.

The group travel or convoy travel can be automatically initiated between the vehicles involved.

The group travel or convoy travel is initiated, for example, by the control and evaluation unit at the vehicle or by the superior control and evaluation unit. The control and evaluation unit, for example, forms a fleet management system.

The control and evaluation unit or the control and evaluation units can, for example, form a control center. An interaction of the control and evaluation unit with a person is also provided, for example. The person can, for example, manually assemble a group or a convoy of vehicles.

In this respect, the person can overwrite a check of specific requirements so that the vehicles can be assembled into a group or convoy.

Fixed groups or convoys can, for example, be formed by the person.

The person can, for example, combine vehicles fixedly into convoys. The person or the superior control and evaluation unit can here form the group or convoy via an external signal. I.e. the group remains formed as long as the external signal is applied.

A group or a convoy can be formed or initiated when vehicles drive in the same direction for a predefined time.

A group or a convoy can be formed when the future common route exceeds a certain minimum length. A route planning of the vehicles is provided for this purpose.

Further requirements are, for example, taken into account by the control and evaluation unit. For example, a workload of a communication channel between the vehicles. A maximum difference of the vehicle speeds, and/or a vehicle width, and/or a vehicle height, and/or a braking distance can, for example, be taken into account in the group forming or the convoy forming.

The route of the group of vehicles can be adapted, for example, such that the common route is maximized.

Since the vehicles have a radio transponder or a radio transceiver, an optical marker at the vehicles can be omitted.

A data exchange can take place fully automatically via the radio location system that is, for example, anyway already present in a factory workshop to determine the position of the vehicles. A user does not have to explicitly program and test the group travel or the convoy travel. The group travel can rather be initiated automatically by the control and evaluation unit or the control and evaluation units.

The formed groups can be coordinated with one another at intersection points to cross over the intersection as efficiently as possible. For example so that the group has to wait as briefly as possible and/or so that the group does not have to be unnecessarily temporarily broken up.

Since the vehicles drive in groups, there are fewer stops of individual vehicles. A more efficient driving of the vehicles in the groups thereby takes place.

An “accordion effect” in which a disruptive compression and stretching of the vehicles of the group would be produced is avoided by the group formation and the communication between the vehicles or by the coordination of the vehicles with one another.

The following vehicles of a group can rely on the protective mechanisms of the first vehicle. Since the vehicles drive at small distances, a space saving on the driving surface takes place.

The distances between the vehicles can be reduced so much that the following vehicles can still brake sufficiently when the first vehicle is braked. This is determined by the response time of the following vehicles and by the latency of the data transmission and possibly by the computing time of the central control and evaluation unit, that is, for example, from the start of the braking of the first vehicle up to the start of the braking of the second vehicle.

In this respect, delay times of different amounts between the vehicles can also be taken into account, for example due to different loads or different brake effects of the vehicles.

The vehicles following the first vehicle profit from the performance of the first vehicle. The first vehicle can thus point the way to the following vehicles of the group. The first vehicle can thus, for example, cope with demands in the route, for example driving on ramps, driving through doors, and/or driving through gates or flaps, or similar, and the following vehicles only have to follow the first vehicle.

In a further development of the invention, the vehicles each have at least one local safety sensor that has at least one protected field at the front side in the direction of travel.

The distance from a preceding vehicle or from obstacles can thus be detected and measured via the safety sensor.

The vehicles optionally each have a local safety sensor that has at least one protected field at the rear side opposite the direction of travel.

The control and evaluation unit is configured to change, to activate, or to deactivate the protected fields of the safety sensors when the vehicles are combined in a group.

The protected field at the front side of the first vehicle of the group can thus have a maximum range and a high response time to drive at a speed that is as fast as possible and the protected fields of the remaining following vehicles are, for example, matched to the preceding vehicle to avoid a collision.

The following vehicles of the group can thus, for example, be operated at a greater speed than their own safety sensors at the front sides of the vehicles would make possible.

When the preceding vehicle of the group is aware of the delay times of the following vehicles of the group, the control and evaluation unit can expand the protected field of the safety sensor of the first vehicle in the direction of travel and can increase the delay time of the vehicle to avoid a collision during braking even though all the group or convoy participants drive at a maximal close distance from one another.

The safety sensor is, for example, a laser scanner, a 3D time of flight camera, or, for example, a stereo camera, an ultrasound sensor, a radar sensor, two irradiation time of flight sensors, or a similar sensor having a protected field or a protected zone.

Time of flight measurement systems make the distance measurement possible by determining the time difference between the transmission of the light and the return of the light reflected by the measurement object.

The time of flight sensor, for example, works according to a direct time of flight process (dTOF), according to which brief light pulses or light pulse groups are transmitted and the time up to the reception of a remission or reflection of the light pulses at an object is measured. The light signals are here formed by light pulses.

However, other time of flight processes are also possible, for example the phase process, according to which transmitted light is amplitude modulated and a phase shift between the transmitted light and the received light is determined, with the phase shift likewise being a measure for the time of flight (indirect time of flight process, iTOF).

Furthermore, a CW (continuous wave) process can be used, with a light signal being used which is constant in time. In this process, for example, the single photon events are distributed via a gating signal into two counters and a phase is calculated from the ratio of the counts.

If some of the vehicles are equipped with local safety sensors (e.g. safety laser scanners or 3D time of flight cameras or stereo cameras), the protected fields of the safety sensors are adapted with reference to the demands from the group or convoy. In the vehicles without local safety sensors, reduced distances are taken into account in the calculation of the safety distances in the control and evaluation unit.

The second following vehicle can, for example, be adapted to the first vehicle.

The protected field length of the second vehicle=the braking distance of the second vehicle−the braking distance of the first vehicle+(time for signal transmission between the first vehicle and the second vehicle) multiplied by (the current speed of the second vehicle minus the current speed of the first vehicle)+minimum distance constant.

The second vehicle drives at a distance from the first vehicle that is specified by the protected field of the second vehicle plus a constant.

The calculation of the minimum distance between the vehicles can be fixedly specified by the manufacturer or can vary dynamically over time.

The load of the vehicles can optionally be taken into account. For example in dependence on the weight or as a further constant or in weight classes.

The distance measurement between the vehicles optionally takes place via the radio location system and/or via the local safety sensors and/or via markers on the floor and/or via incremental encoders on the wheels of the vehicles. A higher measurement accuracy is achieved by a combination of the data sources through data merging, whereby the distances between the vehicles can be minimized.

The additional data can be used for self-tests, for example. The degree of diagnosis coverage of the total system can thereby be increased.

The protected fields of the safety sensors can be adapted.

The protected field is adapted by the following vehicle, for example.

The protected field length is reduced, for example, matching the distance and optionally the current speed of the vehicle.

The protected field width is fixed, for example, to one or more fixedly specified widths. Only vehicles having the same protected field width may form a group, for example. I.e. a coordination within the vehicles with respect to the protected field width is not necessary.

The frontmost vehicle, for example, widens its protected field so much that it also covers the widths of all the following vehicles. The frontmost vehicle, however, requires the information on how wide all the following vehicles are for this purpose.

The outer contour of the preceding vehicle (or a simplified digital representation) is cut out of the protected field of the following vehicle, for example. It is optionally simplified and increased in advance to compensate tolerances.

The local safety sensor of the following vehicle, for example, determines the lateral position of the preceding vehicle with reference e.g. to the right and left margins of the preceding vehicle or with reference to a marker or to a striking feature.

The local safety sensor of the following vehicle, for example, monitors only the right and left margins between the outer edges of its protected field without change due to the convoy travel and the outer edges and the outer edges of the preceding vehicle.

The width of a vehicle can vary over time. E.g. due to transport goods on the vehicle that are wider than the vehicle itself or, for example, due to a robot arm or extendable parts such as supports that project over the base body of the vehicle. I.e. the protected fields have to be updated cyclically, for example. The fewer vehicles have to adjust their protected fields of the safety sensors, the better.

Supplements for statics and/or a dynamic supplement for measurement uncertainty, signal processing times, latency times, cornering, etc. can be taken into account in all the calculations.

An outer contour of the preceding vehicle is cut out of the protected field of the following vehicle, for example. In this case, the preceding vehicle does not to be aware that it is in a group or in a convoy. The preceding vehicle does not adapt its protected field to the following vehicles.

The assumed or cutout zone in the protected field of the following vehicle is displaced depending on where the preceding vehicle is located with respect to the following vehicle. This has the advantage that nothing has to be adjusted when the following vehicle leaves the protected field.

If the first vehicle has higher performance safety sensors or additional sensors than the following vehicles, these following vehicles can then e.g. have a greater speed behind the first vehicle.

In a further development of the invention, the safety sensor detects the position of the preceding vehicle with respect to the position of the vehicle at which the safety sensor is arranged.

The second following vehicle can, for example, be adapted to the first vehicle.

The distance and optionally the protected field of the second, following vehicle can, for example, be reduced with respect to the first, preceding vehicle in the following manners:

The distances are reduced in comparison with the status before the vehicles have formed a group. The distances are reduced in comparison with vehicles that have not been combined into a group.

For example, the distance is reduced between the rear side of the proceeding vehicle and the front side of the following vehicle in the direction of travel when driving straight ahead. When cornering, the distance between the vehicles becomes greater again, for example.

This is advantageous because the measurement accuracy of the local safety sensor is higher than that of the radio location, for example. The following vehicle of the group can thereby drive with a shorter distance from the preceding vehicle in the group.

In a further development of the invention, the control and evaluation unit is configured to associate the vehicle with one of various vehicle classes.

The vehicles are associated with specific distance classes, for example. For example, the size classes S, M, L, and XL.

The classes are, for example fixedly specified by the manufacturer or can be changed by the customer.

Only vehicles of a single class may form a group together, for example.

Optionally, the vehicles of adjacent classes (or optionally only lighter or smaller vehicles) can also form a group or convoy. If vehicles of a plurality of classes may mix, each vehicle then drives at a distance from the preceding vehicle that matches its class and the class of the preceding vehicle.

The class a vehicle belongs to can be fixedly specified by the manufacturer or can vary dynamically over time, for example. The class is dependent, for example, on the braking distance and optionally also on the signal transmission speed between the vehicles and optionally on an additional constant.

In a further development of the invention, the control and evaluation unit is configured to set and to monitor minimal distances between the vehicles.

In a further development of the invention, the control and evaluation unit is configured to synchronize vehicle actions between the vehicles.

User interactions can be synchronized on all and/or on some of the vehicles. All the vehicles can, for example, indicate simultaneously when turning. This has a more uniform appearance and can be recognized better for a human than if only the first vehicle in a longer group or convoy indicates. A horn as a warning is, for example, also louder and can be heard better along the convoy if a plurality of vehicles in particular blow their horns simultaneously.

In a further development of the invention, the control and evaluation unit is configured to vary the order of the vehicles of the group.

A resorting of the vehicles takes place, for example.

If the vehicles or the control and evaluation unit or the control and evaluation units are aware that the vehicles are arranged in a group and drive in a group, their order can also be changed in a targeted manner.

A process optimization takes place, for example. The order of the vehicles can, for example, be changed with reference to process parameters. For example to optimize a subsequent loading and unloading procedure. The most urgent goods are unloaded first, for example, or the non-fragile cases are loaded first and then the fragile ones. A sorting job can thereby be carried out at a vehicle level that would actually take place in downstream process steps.

A vehicle separation can also be prepared, for example. The vehicles can also change their order within the group or convoy in a targeted manner to be able e.g. to split into two partial groups or two partial convoys at a fork of a path. There are then no delay times there due to the resorting directly in the intersection zone.

A group travel or a convoy travel can, for example, be carried out and/or a vehicle can be added to the group or convoy and/or can be removed from the group or convoy and/or convoys in partial groups or in partial convoys can only be made possible in specific spatially limited zones. Optionally also additionally in dependence on the time and/or date and/or on process parameters and/or on the type of vehicle and/or on the cause. A cause can, for example, be an emergency or on a problem in the safety system. A special measure can then be made possible, for example.

A decision on actions can, for example, be made hierarchically, for example in different stages. Similar to an interrupt handling in software.

One or more vehicles can, for example, be decoupled from a group or convoy when the vehicle deviates from the planned route that the first vehicle specifies. A time and a distance can be fixedly specified. A decoupling of a vehicle can take place in dependence on a deviation in time, the distance, and/or in dependence on a speed, a location, or a property of the vehicle (e.g. a greater distance required on a sloping ramp). Deviations due to other objects (e.g. crossing traffic of a person) can be permitted or can result in the decoupling of the vehicle from the convoy.

The most powerful vehicle is arranged at the front in the group, for example. The vehicles can share additional signals within the group or convoy. It may be sensible for the vehicle having the most powerful safety sensors to lead the group or convoy if, for example, a range and/or a resolution of the safety sensor is higher.

For example, if the first vehicle has additional safety sensors in comparison with the following vehicles, these following vehicles can drive a faster speed in the group. The first vehicle can point the way to the other vehicles if they cannot drive up or down a ramp, for example.

In the event of a defect, for example, the group or convoy can be split to provide space for a repair to the vehicle that has a defect.

In a further development of the invention, the control and evaluation unit is configured to grant priority to the group of vehicles over an individual vehicle or a group of vehicles having a lower number of vehicles.

At intersection points, for example, groups or convoys of vehicles, optionally from a certain number of vehicles onward, can be granted priority over vehicles driving alone.

Alternatively, coordination can take place between different groups or convoys or of a convoy having one vehicle with the aim of using the intersection zone as efficiently as possible. For example, groups or convoys are not split or are only split at designated points. Provision can also be made to combine vehicles into groups or convoys at intersection points to detect an efficient crossing of intersection points.

Groups or convoys can, for example, be split before zones in which no data exchange is possible between the vehicles or between vehicles and the superior control and evaluation unit. The group or convoy is split up in front of such a zone, for example. The protected fields and thus the distances are then increased so that every vehicle again drives on its own.

In a further development of the invention, the control and evaluation unit is configured to evaluate and compare odometry data of the vehicles within the group.

Consistency checks take place, for example, based on the odometry data of the vehicles that participate in a group or convoy. For example on that part of the group that can also deliver odometry data, that is a subset of the group, for example the first and last vehicles in a group or convoy. Failsafeness is thereby increased. Odometry data can, for example, be from acceleration sensors, incremental encoders on a wheel of a vehicle, and/or data from steering sensors of the wheels of the vehicle.

The odometry data have to be the same or consistent in a group or convoy within a certain interval, possibly with small time delays because not all the vehicles brake, accelerate, or take a corner simultaneously.

A height and/or a width of a preceding vehicle can be determined, for example. A measurement takes place, for example, using local safe or unsafe sensors, e.g. using a laser scanner or a 3D time of flight camera.

The odometry data have to remain constant over a certain time period within a certain tolerance framework. The tolerance framework is, for example, either fixedly specified or can, for example, be configured or is, for example, dynamically dependent on at least one of the following parameters:
1. Tolerances such as measurement accuracy
2. Deviations due to measurements during cornering
3. Deviations when a vehicle drives up onto a ramp and a second following vehicle is still in front of the ramp or when a vehicle drives down off a ramp and a second following vehicle is still on the ramp.

A calculation of the odometry data optionally takes place via floating filters, e.g. Kalman or mean value filters or low pass filters.

In a further development of the invention, a check unit is provided in addition to the control and evaluation unit, with the check unit being configured to check the control and evaluation unit.

The check unit can also be called a watchdog.

In a further development of the invention, a group signal is cyclically transmitted to the check unit by the control and evaluation unit. The control and evaluation unit is configured to cyclically transmit the group signal.

A group signal or a convoy signal has to be refreshed, for example cyclically, in accordance with the further development in order, for example, to maintain a reduction in size of the protected field, for example for a masking of the protected field for the preceding vehicle. Without a refresh of the group signal or convoy signal, a timer in the column runs out and the control and evaluation unit switches the safety sensor back to its original normal protected field again, that is to the protected field the vehicle would have had at the speed, etc. if the vehicle were to drive outside a convoy. A degree of diagnosis coverage is thereby increased.

In a further development of the invention, vehicles of a group transport a common load.

For example, the vehicles have the matching heights and widths ex works or the object holders are set in a matching manner for this purpose by the vehicles themselves or by a superior system. The at least two vehicles that form a group or convoy e.g. set their worktables at the same height and drive behind one another. These vehicles can thus together transport a workpiece for which a single vehicle would have too short a load surface. The advantage in comparison with vehicles that cannot drive in a group or convoy is that the present vehicles can drive closer together and the distance between the vehicles remains more constant. The vehicles in accordance with the further development can therefore carry larger loads. The vehicles moreover transport the loads more reliably since there is a smaller risk that the load may fall into a gap between the two vehicles when the first vehicle accelerates and the second vehicle has not yet accelerated.

In a further development of the invention, one vehicle transports a plurality of vehicles of a common group.

A train of vehicles is formed, for example. Groups or convoys of small vehicles can be loaded onto a larger vehicle for longer distances to move forward faster or to increase the range.

Provision can, for example, be made to form an emergency lane. In this case, the vehicle is not simply stopped in an emergency, but is rather driven to the side to form a free lane or an emergency lane.

### BRIEF DESCRIPTION OF THE DRAWINGS

The invention will also be explained in the following with respect to further advantages and features with reference to the enclosed drawing and embodiments. The Figures of the drawing show in:

FIGS. 1 to 8 respectively, a safety system for the localization of at least two vehicles;

In the following Figures, identical parts are provided with identical reference numerals.

FIG. 1 shows a safety system 1 for the localization of at least two vehicles 2, having at least one control and evaluation unit 3, having at least one radio location system 4, wherein the radio location system 4 has at least three arranged radio stations 5, wherein at least one device 7 having at least one radio transponder 6 is arranged at the vehicles 2, wherein the radio location system 4 is configured to determine position data of the radio transponder 6 and thus to determine position data of the vehicles 2, wherein the position data can be transmitted from the radio station 5 of the radio location system 4 to the control and evaluation unit 3 and/or the position data can be transmitted from the radio transponder 6 to the control and evaluation unit 3, wherein the control and evaluation unit 3 is configured to cyclically detect the position data of the radio transponder 6, wherein the radio transponder 6 has an identification, wherein the control and evaluation unit 3 is configured to distinguish the vehicles 2, wherein the control and evaluation unit 3 is configured to control the vehicles 2, wherein the control and evaluation unit 3 is configured to combine the vehicles 2 into groups 8 driving in the same direction based on the position data of the vehicles 2, and wherein the control and evaluation unit 3 is configured to reduce the distances between the vehicles 2 of a group 8.

FIG. 2 shows a safety system 1 for the localization of at least two vehicles 2, having at least one control and evaluation unit 3 per vehicle, having at least one radio location system 4, wherein the radio location system 4 has at least one arranged radio transceiver 12 at the vehicle 2, wherein the radio location system 4 is configured to determine distance data of the radio transceiver 12 and thus to determine distance data of the vehicles 2, wherein the distance data can be transmitted from the radio transceiver 12 of the radio location system 4 to the control and evaluation unit 3, wherein the control and evaluation unit 3 is configured to cyclically detect the distance data of the radio transceiver 12, wherein the radio transceiver 12 has an identification, wherein the control and evaluation unit 3 is configured to distinguish the vehicles 2, wherein the control and evaluation unit 3 is configured to control at least the vehicle 2, wherein the control and evaluation unit 3 is configured to combine the vehicles 2 into groups 8 driving in the same direction based on the distance data of the vehicles 2, and wherein the control and evaluation unit 3 is configured to reduce the distances between the vehicles 2 of a group 8.

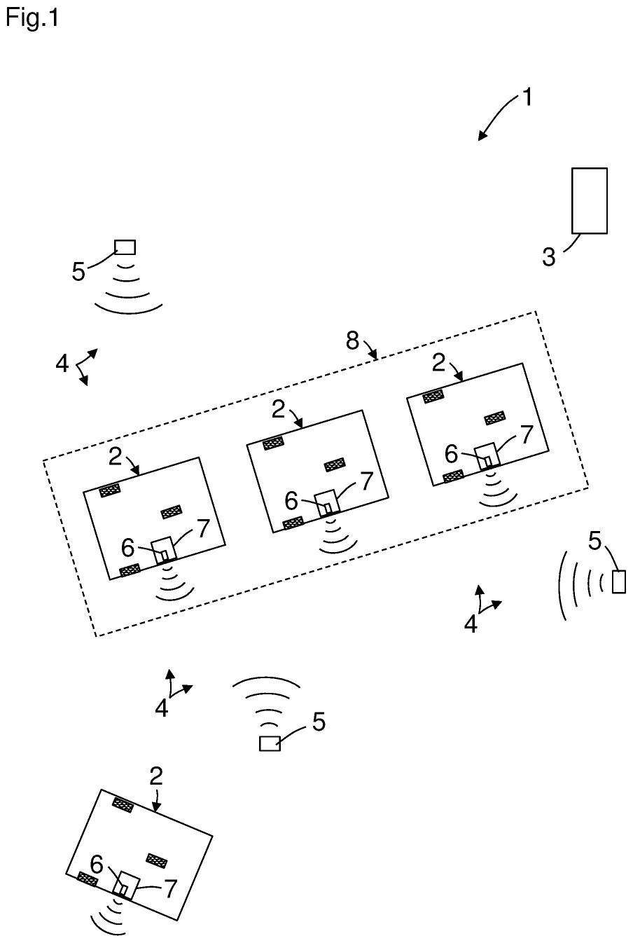

In accordance with FIG. 1, the signals of a radio transponder 6 are received by a plurality of fixed position radio stations 5 or anchor stations and the basis for the localization is created via a time of flight measurement, e.g. the time of arrival (TOA) or e.g. the time difference of arrival (TDOA). The calculation or estimation of the position of a radio transponder 6 then takes place on the control and evaluation unit 3, for example an RTLS (real time location system) server that is connected to all the radio stations or anchor stations 5 via a wireless or wired data link. This mode of localization is called an RTLS (real time location system) mode.

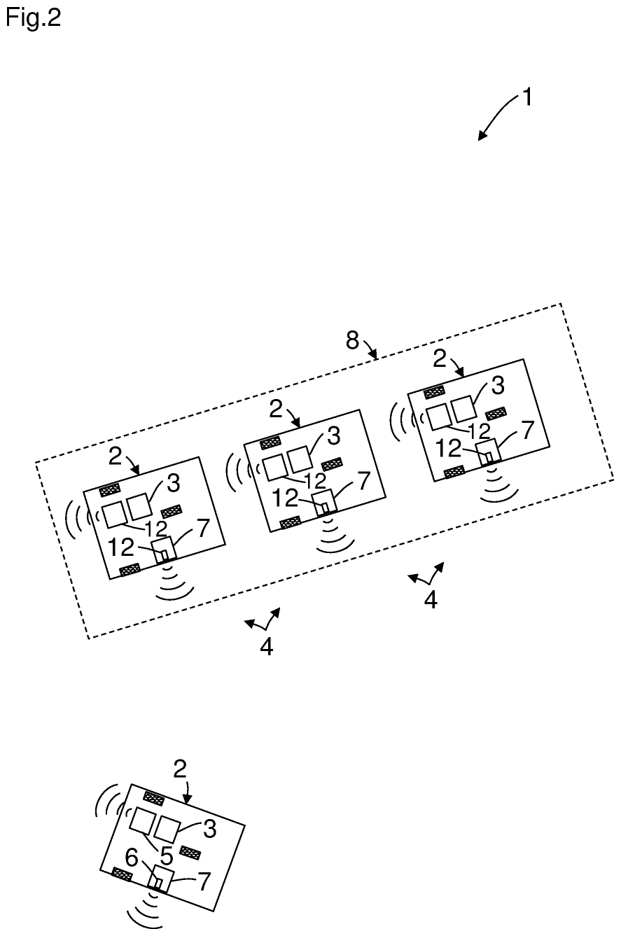

In accordance with FIG. 2, the signals of a radio transceiver 12 on a vehicle 2 are received by at least one radio transceiver 12 on a different vehicle 2 and the basis for a distance measurement is created via a time of flight measurement, e.g. the time of arrival (TOA). The calculation or estimation of the distance of a radio transceiver 12 then takes place on the control and evaluation unit 3 having the connected radio transceiver 12. The vehicles 2 here exchange their distances and the control signals for the group or convoy between one another.

At least two vehicles 2 or a plurality of vehicles 2 are present, for example, and are underway in a factory workshop, for example.

The vehicle 2 can, for example, be a guideless vehicle 2, a driverless vehicle 2 or an autonomous vehicle 2, an autonomous guided vehicle 2 (AGV), an autonomous mobile robot (AMR), an industrial mobile robot (IMR), or a robot having movable robot arms. The vehicle 2 thus has a drive and can be moved in different directions.

Persons can furthermore be present and can, for example, be underway in a factory workshop. The person can, for example, be an operator or a service engineer.

Data or information can be exchanged between the vehicles 2 over the radio location system 4.

The possibility of the vehicles 2 being able to merge into a group 8 or convoy is recognized with reference to the position of the vehicles 2 among one another. The group 8, the group travel or convoy travel is initiated, for example, when certain requirements have been satisfied. For example, a planned common route.

As soon as the vehicles 2 have been combined into a group 8, the distances between the vehicles 2 can be set. As soon as the vehicles 2 drive in the same direction, the distances between the vehicles 2 of a group 8 are reduced or minimized.

A permitted minimum distance is provided between the vehicles 2, for example. The minimum distance can be set in dependence on the current speed of the vehicle 2.

Control signals are exchanged between the vehicles 2, for example. When the vehicles 2 have been combined into a group 8 or convoy, the vehicles 2 control themselves between one another or the superior control and evaluation unit 3 controls the vehicles 2 such that the distances between the vehicles 2 are minimal.

Braking signals are exchanged between the vehicles 2, for example. When a vehicle 2 initiates a braking procedure, a signal is sent so that all the following vehicles 2 also initiate a braking procedure.

Acceleration signals are exchanged between the vehicles 2, for example. When the first vehicle 2 accelerates, it sends a signal to the other vehicles 2 so that these vehicles 2 also accelerate.

If all the vehicles 2 are not centrally controlled, the signals are forwarded, for example, from one vehicle 2 to the next vehicle 2 in the group or chain.

Control signals are exchanged between the vehicles 2, for example. All the vehicles 2 in the group 8 or convoy can thus also be braked, for example, that is also the preceding vehicles 2. It can thus be prevented that the group 8 or convoy falls apart when a middle, a rear, or, for example, the last vehicle 2 brakes.

The group travel or convoy travel can be automatically initiated between the vehicles 2 involved.

The group travel or convoy travel is initiated, for example, by the control and evaluation unit 3 at the vehicle 2 or by the superior control and evaluation unit 3. The control and evaluation unit 3, for example, forms a fleet management system.

The control and evaluation unit 3 or the control and evaluation units 3 can, for example, form a control center. An interaction of the control and evaluation unit 3 with a person is also provided, for example. The person can, for example, manually assemble a group 8 or a convoy of vehicles 2.

In this respect, the person can overwrite a check of specific requirements so that the vehicles 2 can be assembled into a group 8 or convoy.

Fixed groups 8 or convoys can, for example, be formed by the person. The person can, for example, combine vehicles 2 fixedly into convoys. The person or the superior control and evaluation unit 3 can here form the group 8 or convoy via an external signal. I.e. the group 8 remains formed as long as the external signal is applied.

A group 8 or a convoy can be formed or initiated when vehicles 2 drive in the same direction for a predefined time.

A group 8 or a convoy can be formed when the future common route of the vehicles 2 exceeds a certain minimum length. A route planning of the vehicles 2 is provided for this purpose.

Further requirements are, for example, taken into account by the control and evaluation unit 3. For example, a workload of a communication channel between the vehicles 2. A maximum difference of the vehicle speeds, and/or a vehicle width, and/or a vehicle height, and/or a braking distance can, for example, be taken into account in the group forming or the convoy forming.

The route of the group 8 of vehicles 2 can be adapted, for example, such that the common route is maximized.

A data exchange can take place fully automatically via the radio location system 4 that is, for example, anyway already present in a factory workshop to determine the position of the vehicles 2. A user does not have to explicitly program and test the group travel or the convoy travel. The group travel is rather initiated automatically by the control and evaluation unit 3 or the control and evaluation units 3.

The formed groups 8 can be coordinated with one another at intersection points to cross over the intersection as efficiently as possible. For example so that the group 8 has to wait as briefly as possible and/or so that the group 8 does not have to be unnecessarily temporarily broken up.

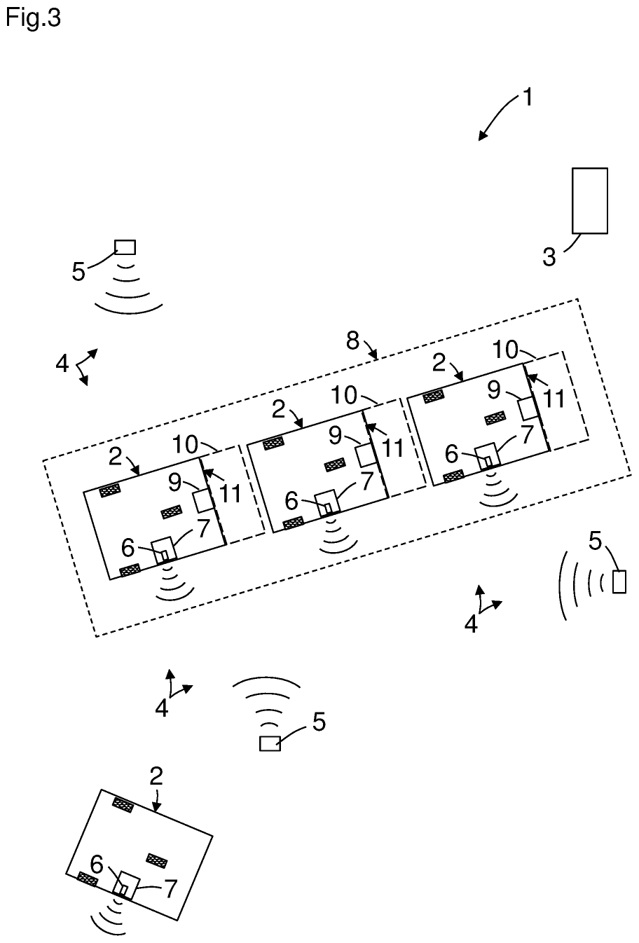

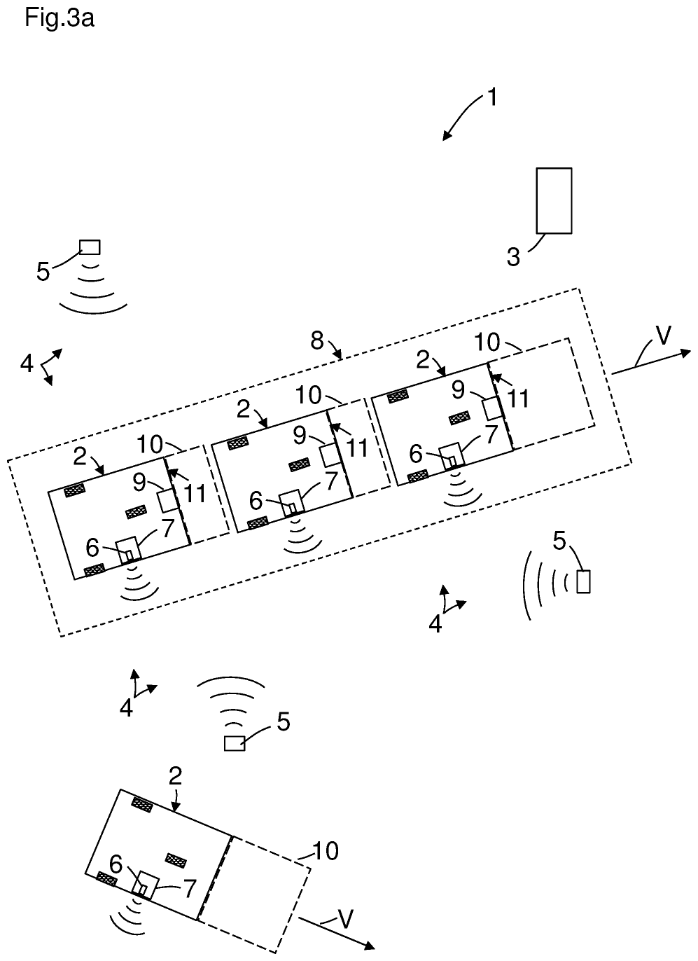

In accordance with FIG. 3, the vehicles 2 each have at least one local safety sensor 9 that has at least one protected field 10 at the front side 11 in the direction of travel. The example in accordance with FIG. 2 can also have the safety sensors.

The distance from a preceding vehicle 2 or from obstacles can thus be detected and measured via the safety sensor 9.

The vehicles 2 optionally each have a local safety sensor 9 that has at least one protected field 10 at the rear side opposite the direction of travel.

The control and evaluation unit 3 is configured to change, to activate, or to deactivate the protected fields 10 of the safety sensors 9 when the vehicles 2 are combined in a group 8.

The protected field 10 at the front side 11 of the first vehicle 2 of the group 8 can thus have a maximum range and a high response time to drive at a speed that is as fast as possible and the protected fields 10 of the remaining following vehicles 2 are, for example, matched to the preceding vehicle 2 to avoid a collision.

When the preceding vehicle 2 of the group 8 is aware of the delay times of the following vehicles 2 of the group 8, the control and evaluation unit 3 can expand the protected field 10 of the safety sensor 9 of the first vehicle 2 in the direction of travel and can increase the delay time of the vehicle 2 to avoid a collision during braking even though all the group or convoy participants drive at a maximal close distance from one another.

The safety sensor 9 is, for example, a laser scanner a 3D time of flight camera, or, for example, a stereo camera, or a similar sensor having a protected field or a protected zone.

The protected fields 10 of the safety sensors 9 can be adapted.

The protected field 10 is adapted by the following vehicle 2, for example. The protected field length is reduced, for example, matching the distance and optionally the current speed of the vehicle 2.

The protected field width is fixed, for example, to one or more fixedly specified widths. Only vehicles 2 having the same protected field width may form a group 8, for example. I.e. a coordination within the vehicles 2 with respect to the protected field width is not necessary.

The frontmost vehicle 2, for example, widens its protected field 10 so much that it also covers the widths of all the following vehicles 2. The frontmost vehicle 2, however, requires the information on how wide all the following vehicles 2 are for this purpose.

The outer contour of the preceding vehicle 2 (or a simplified digital representation) is cut out of the protected field 10 of the following vehicle 2, for example. It is optionally simplified and increased in advance to compensate tolerances.

The control and evaluation unit 3 is configured to associate the vehicle 2 with one of various vehicle classes.

The vehicles 2 are associated with specific distance classes, for example. For example, the size classes S, M, L, and XL.

Only vehicles 2 of a single class may form a group 8 together, for example.

Optionally, the vehicles 2 of adjacent classes (or optionally only lighter or smaller vehicles) can also form a group 8 or convoy. If vehicles 2 of a plurality of classes my mix, each vehicle 2 then drives at a distance from the preceding vehicle 2 that matches its class and the class of the preceding vehicle 2.

For example, the control and evaluation unit 3 is configured to set and to monitor minimal distances between the vehicles 2.

For example, the control and evaluation unit 3 is configured to synchronize vehicle actions between the vehicles 2.

User interactions can be synchronized on all and/or on some of the vehicles 2. All of the vehicles 2 can, for example, indicate simultaneously when turning.

For example, the control and evaluation unit 3 is configured to vary the order of the vehicles 2 of the group 8.

A resorting of the vehicles 2 takes place, for example, by the control and evaluation unit 3.

A process optimization takes place, for example. The order of the vehicles 2 can, for example, be changed with reference to process parameters. For example to optimize a subsequent loading and unloading procedure.

A vehicle separation can be prepared, for example. The vehicles 2 can also change their order within the group 8 or convoy in a targeted manner to be able e.g. to split into two partial groups or two partial convoys at a fork of a path.

A group travel or a convoy travel can, for example, be carried out and/or a vehicle 2 can be added to the group 8 or convoy and/or can be removed from the group 8 or convoy and/or convoys in partial groups or in partial convoys can only be made possible in specific spatially limited zones.

One or more vehicles 2 can, for example, be decoupled from a group 8 or convoy when the vehicle 2 deviates from the planned route that the first vehicle 2 specifies.

The most powerful vehicle 2 is arranged at the front in the group 8, for example. The vehicles 2 can share additional signals within the group 8 or convoy. It may be sensible for the vehicle 2 having the most powerful safety sensors 9 to lead the group 8 or convoy if, for example, a range and/or a resolution of the safety sensor 9 is higher.

For example, the control and evaluation unit 3 is configured to give way to the group 8 of vehicles 2 over an individual vehicle 2 or a group 8 of vehicles 2 having a lower number of vehicles 2.

At intersection points, for example, groups 8 or convoys of vehicles 2, optionally from a certain number of vehicles 2 onward, can be granted priority over vehicles 2 driving alone.

Alternatively, coordination can take place between different groups 8 or convoys or of a convoy having one vehicle 2 with the aim of using the intersection zone as efficiently as possible. For example, groups 8 or convoys are not split or are only split at designated points. Provision can also be made to combine vehicles 2 into groups 8 or convoys at intersection points to detect an efficient crossing of intersection points.

For example, the control and evaluation unit 3 is configured to evaluate and compare odometry data of the vehicles 2 within the group.

Consistency checks take place, for example, based on the odometry data of the vehicles 2 that participate in a group 8 or convoy. For example on that part of the group 8 that can also deliver odometry data, that is a subset of the group 8, for example the first and last vehicles 2 in a group 8 or convoy. Failsafeness is thereby increased. Odometry data can, for example, be from acceleration sensors, incremental encoders on a wheel of a vehicle 2, and/or data from steering sensors of the wheels of the vehicle 2.

In accordance with FIG. 3a, the vehicles 2 each have at least one local safety sensor 9 that has at least one protected field 10 at the front side 11 in the direction of travel. The first or frontmost vehicle 2 has a protected field 10 since no vehicle 2 drives in front of it. The protected field 10 of the vehicle driving alone likewise has a longer protected field since likewise no vehicle 2 drives in front of it. Following vehicles 2 have shorter protected fields or smaller protected fields. All the vehicles in accordance with FIG. 3a have a speed V. The vehicles of the group 8 have the same speed V.

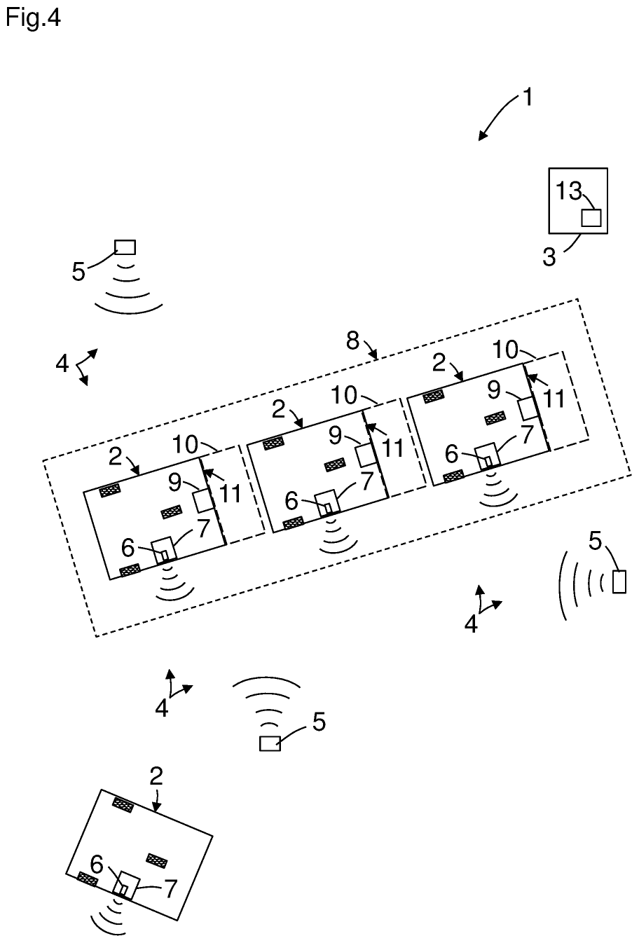

For example, in accordance with FIG. 4, a check unit 13 is provided in addition to the control and evaluation unit 3, with the check unit 13 being configured to check the control and evaluation unit 3. The check unit 13 can also be called a watchdog. A check unit 13 can also be provided in addition to the control and evaluation unit 3 in the example in accordance with FIG. 2.

A group signal or a convoy signal has to be refreshed, for example cyclically, in order, for example, to maintain a reduction in size of the protected field 10, for example for a masking of the protected field 10 for the preceding vehicle 2. Without a refresh of the group signal or convoy signal, a timer in the control and evaluation unit 3 runs out and the control and evaluation unit 3 switches the safety sensor 9 back to its original normal protected field 10 again, that is to the protected field 10 the vehicle 2 would have had at the speed, etc. if the vehicle 2 were to drive outside a convoy. A degree of diagnosis coverage is thereby increased.

Vehicles 2 of a group 8, for example, transport a common load.

One vehicle 2, for example, transports a plurality of vehicles 2 of a common group 8.

A train of vehicles is formed, for example. Groups 8 or convoys of small vehicles 2 can be loaded onto a larger vehicle 2 for longer distances to move forward faster or to increase the range.

Provision can, for example, be made to form an emergency lane. In this case, the vehicle 2 is not simply stopped in an emergency, but is rather driven to the side to form a free lane or an emergency lane.

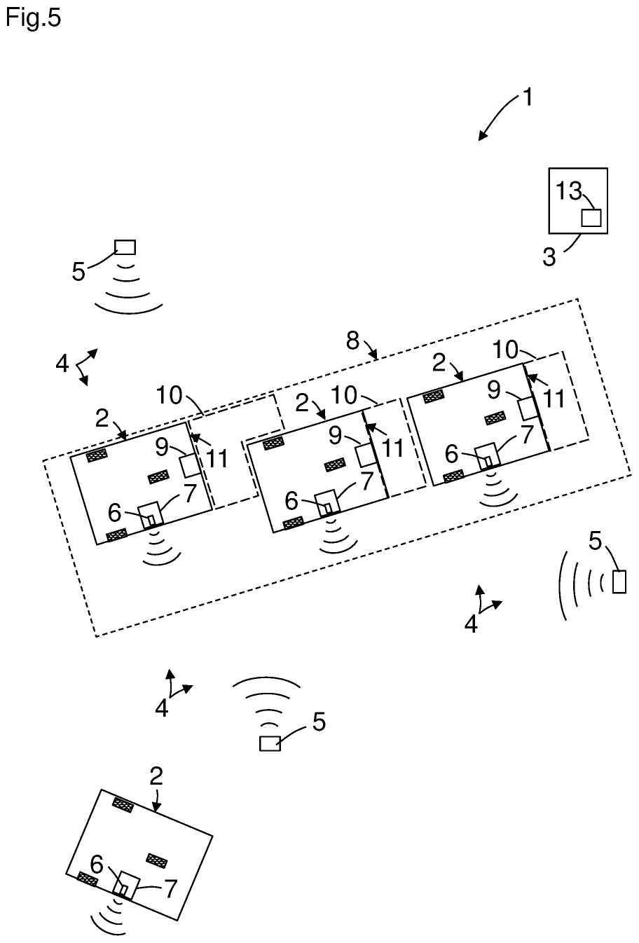

In accordance with FIG. 5, the vehicles 2 each have at least one local safety sensor 9 that has at least one protected field 10 at the front side 11 in the direction of travel. The last vehicle 2 in the group 9 drives laterally offset from the front vehicles 2. The protected field 10 of the last vehicle 2 is corresponding laterally extended since the left part of the rearmost vehicle 2 is not covered by the protected field 10 of the preceding vehicle 2.

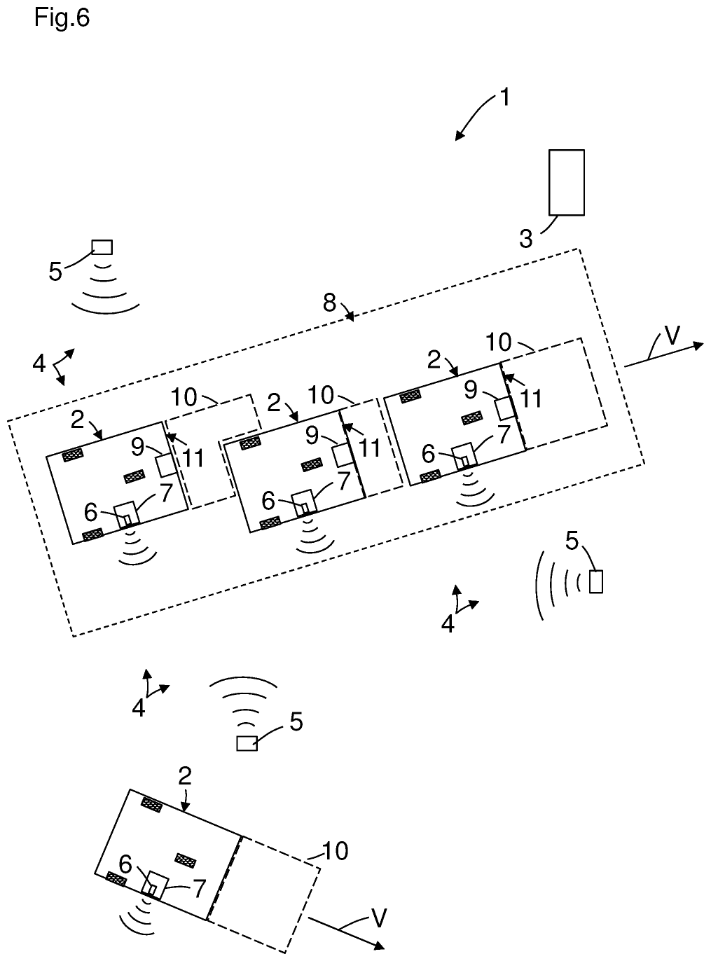

In accordance with FIG. 6, the vehicles 2 each have at least one local safety sensor 9 that has at least one protected field 10 at the front side 11 in the direction of travel. The first or frontmost vehicle 2 has a protected field 10 since no vehicle 2 drives in front of it. The protected field 10 of the vehicle driving alone likewise has a longer protected field since likewise no vehicle 2 drives in front of it. Following vehicles 2 have shorter or smaller protected fields. All the vehicles in accordance with FIG. 6 have a speed V. The vehicles of the group 8 have the same speed V. The last vehicle 2 in the group 8 drives laterally offset from the front vehicles 2. The protected field 10 of the last vehicle 2 is corresponding laterally extended since the left part of the rearmost vehicle 2 is not covered by the protected field 10 of the preceding vehicle 2.

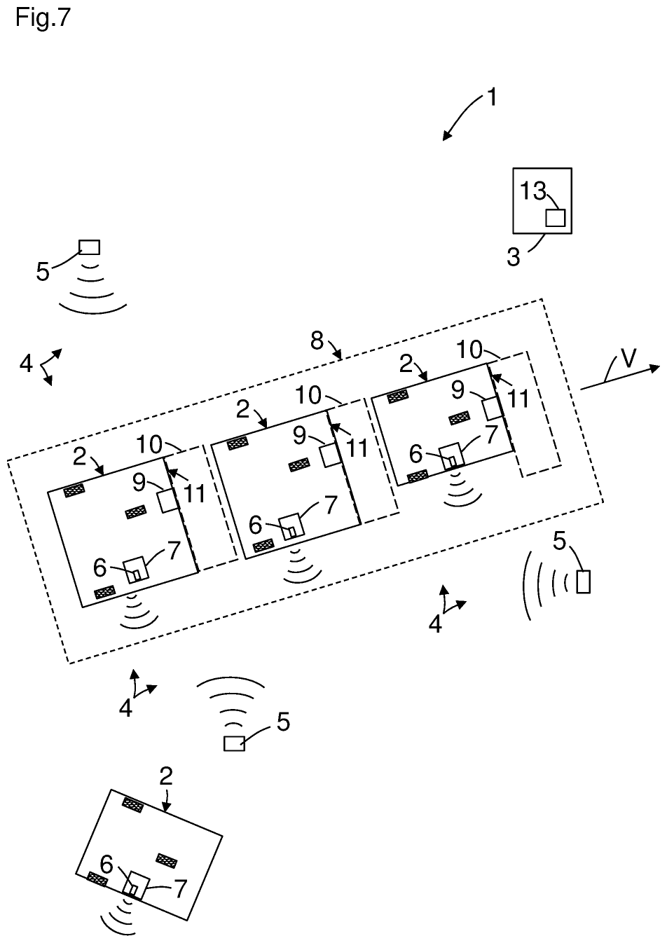

In accordance with FIG. 7, the vehicles 2 each have at least one local safety sensor 9 that has at least one protected field 10 at the front side 11 in the direction of travel. The first or frontmost vehicle 2 has a wider protected field 10 since the following vehicles 2 are wider than the first vehicle 2. Following vehicles 2 have protected fields of the same width. All the vehicles in accordance with FIG. 6 have a speed V. The vehicles of the group 8 have the same speed V.

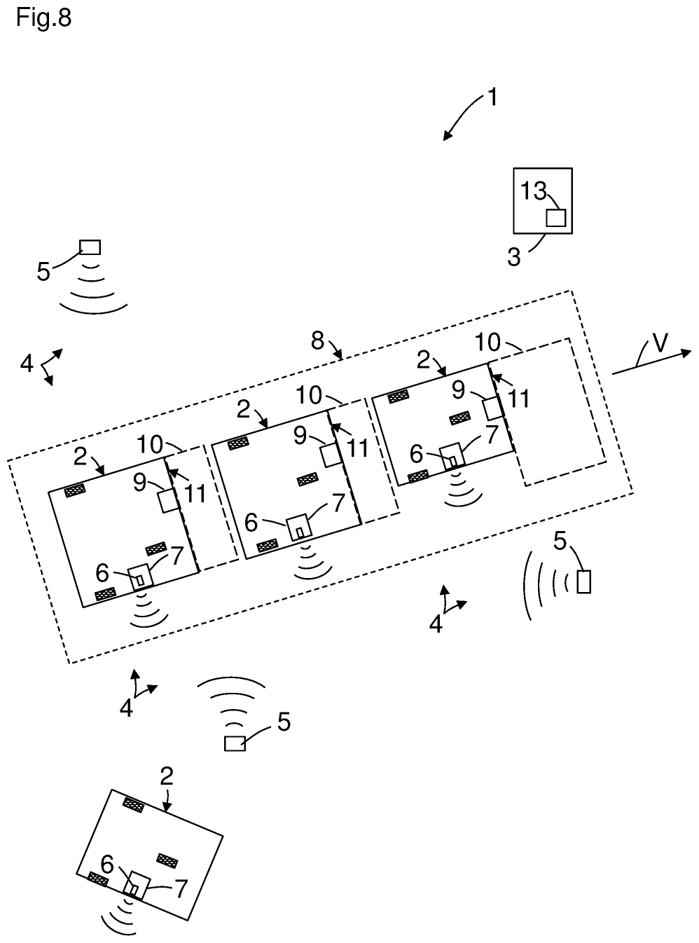

In accordance with FIG. 8, the vehicles 2 each have at least one local safety sensor 9 that has at least one protected field 10 at the front side 11 in the direction of travel. The first or frontmost vehicle 2 has a wider protected field 10 since the following vehicles 2 are wider than the first vehicle 2. Following vehicles 2 have protected fields of the same width. The first or frontmost vehicle 2 has a protected field 10 since no vehicle 2 drives in front of it. The protected field 10 of the vehicle driving alone likewise has a longer protected field since likewise no vehicle 2 drives in front of it. Following vehicles 2 have shorter or smaller protected fields. All the vehicles in accordance with FIG. 6 have a speed V. The vehicles of the group 8 have the same speed V.

### REFERENCE NUMERALS

1 safety system
2 vehicles
3 control and evaluation unit
4 radio location system
5 radio stations
6 radio transponder
7 device
8 group
9 safety sensor
10 field
11 front side of the vehicle
12 radio transceiver
13 check unit
V speed

1. A safety system for the localization of at least two vehicles, the safety system having at least one control and evaluation unit, and at least one radio location system,
wherein the radio location system has at least three arranged radio stations;
wherein at least one device having at least one radio transponder is arranged at the vehicles;
wherein the radio location system is configured to determine position data of the radio transponder and thus position data of the vehicles;
wherein the position data can be transmitted from the radio station of the radio location system to the control and evaluation unit;
and/or wherein the position data can be transmitted from the radio transponder to the control and evaluation unit,
wherein the control and evaluation unit is configured to cyclically detect the position data of the radio transponder;
wherein the radio transponder has an identification;
wherein the control and evaluation unit is configured to distinguish the vehicles;
wherein the control and evaluation unit is configured to control the vehicles;
wherein the control and evaluation is configured to combine the vehicles into groups driving in the same direction based on the position data of the vehicles, and wherein the control and evaluation unit is configured to reduce the distances between the vehicles of a group.

2. The safety system in accordance with claim 1, wherein the vehicles each have at least one local safety sensor at the front side in the direction of travel.

3. The safety system in accordance with claim 3, wherein the safety sensor detects the position of the preceding vehicle with respect to the position of the vehicle at which the safety sensor is arranged.

4. The safety system in accordance with claim 1, wherein the control and evaluation unit is configured to associate the vehicle with one of different vehicle classes.

5. The safety system in accordance with claim 1, wherein the control and evaluation unit is configured to set and to monitor minimal distances between the vehicles.

6. The safety system in accordance with claim 1, wherein the control and evaluation unit is configured to synchronize vehicle actions between the vehicles.

7. The safety system in accordance with claim 1, wherein the control and evaluation unit is configured to vary the order of the vehicles of the group.

8. The safety system in accordance with claim 1, wherein the control and evaluation unit is configured to grant priority to the group of vehicles over an individual vehicle or a group of vehicles having a lower number of vehicles.

9. The safety system in accordance with claim 1, wherein the control and evaluation unit is configured to evaluate and to compare odometry data of the vehicle within the group.

10. The safety system in accordance with claim 1, wherein a check unit is provided in addition to the control and evaluation unit, with the check unit being configured to check the control and evaluation unit.

11. The safety system in accordance with claim 10, wherein a group signal is cyclically transmitted to the check unit by the control and evaluation unit.

12. The safety system in accordance with claim 1, wherein vehicles of a group transport a common load.

13. The safety system in accordance with claim 1, wherein one vehicle transports a plurality of vehicles of a common group.

14. A safety system for the localization of at least two vehicles, the safety system having at least one control and evaluation unit per vehicle, and at least one radio location system,
wherein the radio location system has at least one arranged radio transceiver at the vehicle;
wherein the radio location system is configured to determine distance data of the radio transceiver and thus distance data of the vehicles;
wherein the distance data can be transmitted from the radio transceiver of the radio location system to the control and evaluation unit,
wherein the control and evaluation unit is configured to cyclically detect the distance data of the radio transceiver;
wherein the radio transceiver has an identification;
wherein the control and evaluation unit is configured to distinguish the vehicles;
wherein the control and evaluation unit is configured to control at least the vehicle;
wherein the control and evaluation unit is configured to combine the vehicles into groups driving in the same direction based on the distance data of the vehicles, and wherein the control and evaluation unit is configured to reduce the distances between the vehicles of a group.

15. The safety system in accordance with claim 14, wherein the vehicles each have at least one local safety sensor at the front side in the direction of travel.

16. The safety system in accordance with claim 15, wherein the safety sensor detects the position of the preceding vehicle with respect to the position of the vehicle at which the safety sensor is arranged.

17. The safety system in accordance with claim 14, wherein the control and evaluation unit is configured to associate the vehicle with one of different vehicle classes.

18. The safety system in accordance with claim 14, wherein the control and evaluation unit is configured to set and to monitor minimal distances between the vehicles.

19. The safety system in accordance with claim 14, wherein the control and evaluation unit is configured to synchronize vehicle actions between the vehicles.

20. The safety system in accordance with claim 14, wherein the control and evaluation unit is configured to vary the order of the vehicles of the group.

21. The safety system in accordance with claim 14, wherein the control and evaluation unit is configured to grant priority to the group of vehicles over an individual vehicle or a group of vehicles having a lower number of vehicles.

22. The safety system in accordance with claim 14, wherein the control and evaluation unit is configured to evaluate and to compare odometry data of the vehicle within the group.

23. The safety system in accordance with claim 14, wherein a check unit is provided in addition to the control and evaluation unit, with the check unit being configured to check the control and evaluation unit.

24. The safety system in accordance with claim 23, wherein a group signal is cyclically transmitted to the check unit by the control and evaluation unit.

25. The safety system in accordance with claim 14, wherein vehicles of a group transport a common load.

26. The safety system in accordance with claim 14, wherein one vehicle transports a plurality of vehicles of a common group.

27. A method of localizing at least two vehicles, having at least one control and evaluation unit, having at least one radio location system,
wherein the radio location system has at least three arranged radio stations;
wherein at least one device having at least one radio transponder is arranged at the vehicles;
wherein position data of the radio transponder and thus position data of the vehicles can be determined by means of the radio location system;
wherein the position data can be transmitted from the radio station of the radio location system to the control and evaluation unit;
and/or wherein the position data can be transmitted from the radio transponder to the control and evaluation unit,
wherein the control and evaluation unit is configured to cyclically detect the position data of the radio transponder,
wherein the radio transponder has an identification;
wherein the control and evaluation unit is configured to distinguish the vehicles;
wherein the control and evaluation unit is configured to control the vehicles;
wherein the control and evaluation is configured to combine the vehicles into groups driving in the same direction based on the position data distance data of the vehicles, and wherein the control and evaluation unit is configured to reduce the distances between the vehicles of a group.

28. A method of localizing at least two vehicles, having at least one control and evaluation unit per vehicle, having at least one radio location system,
wherein the radio location system has at least one arranged radio transceiver at the vehicle;
wherein distance data of the radio transceiver and thus distance data of the vehicles can be determined by means of the radio location system;
wherein the distance data can be transmitted from the radio transceiver of the radio location system to the control and evaluation unit,
wherein the control and evaluation unit is configured to cyclically detect the distance data of the radio transceiver;
wherein the radio transceiver has an identification;
wherein the control and evaluation unit is configured to distinguish the vehicles;
wherein the control and evaluation unit is configured to control at least the vehicle;
wherein the control and evaluation is configured to combine the vehicles into groups driving in the same direction based on the distance data of the vehicles, and wherein the control and evaluation unit is configured to reduce the distances between the vehicles of a group.
